(19) United States
(12) Patent Application Publication
(10) Pub. No.: US 2015/0234536 A1
(43) Pub. Date: Aug. 20, 2015

(54) INPUT APPARATUS

(71) Applicant: ALPS ELECTRIC CO., LTD., Tokyo (JP)

(72) Inventors: Tatsumaro Yamashita, Miyagi-ken (JP); Takehito Sugawara, Miyagi-ken (JP)

(21) Appl. No.: 14/705,434

(22) Filed: May 6, 2015

Related U.S. Application Data
(63) Continuation of application No. PCT/JP2013/079091, filed on Oct. 28, 2013.

(30) Foreign Application Priority Data
Nov. 8, 2012 (JP) 2012-246162
Mar. 18, 2013 (JP) 2013-055287

(51) Int. Cl. G06F 3/041; G06F 3/0488

(52) U.S. Cl. CPC G06F 3/0416; G06F 3/04883

(57) ABSTRACT

An input apparatus includes a central operation unit and a controller that controls an input operation to the central operation unit. The controller includes a determination unit that determines whether the central operation unit is going to be operated from, at least, a left side of the central operation unit or a right side thereof and a reference change unit that changes an operation reference direction of the operation unit in plan view in accordance with a determination result of the determination unit. When it is determined that the operation unit is going to be operated by a driver, the operation reference direction is changed to another direction. When it is determined that the operation unit is going to be operated by a passenger on a passenger seat, the operation reference direction is changed to still another direction.

### CLAIM OF PRIORITY

This application is a Continuation of International Application No. PCT/JP2013/079091 filed on Oct. 28, 2013, which claims benefit of priority to Japanese Patent Application No. 2012-246162 filed on Nov. 8, 2012. The entire contents of each application noted above are hereby incorporated by reference.

### BACKGROUND

1. Field of the Disclosure

The present disclosure relates to control of an operation reference direction of an operation unit included in an input apparatus.

2. Description of the Related Art

Japanese Unexamined Patent Application Publication No. 2007-302154 discloses a vehicle-mounted input apparatus. This vehicle-mounted input apparatus includes an input operation unit disposed between a driver seat and a passenger seat. Whether the input operation unit is going to be operated by a driver on the driver seat or a passenger on the passenger seat can be determined by using an optical switch.

Japanese Unexamined Patent Application Publication No. 2008-158675 discloses an operation apparatus for a vehicle. The operation apparatus performs control as follows: when an operation unit is operated by a finger, a display unit displays the finger such that the finger has a smaller size than the actual one in order to facilitate operation of an operation switch.

In each of the apparatus disclosed in Japanese Unexamined Patent Application Publication Nos. 2007-302154 and 2008-158675, an operating sensation provided to a driver is not different from that to a passenger on the passenger seat.

For example, it is assumed that an operation unit is disposed in a center console between a driver seat and a passenger seat. As illustrated in FIG. 16, an operation unit 3 is not in front of an operator, i.e., a driver 1 or a passenger 2 on the passenger seat. The operation unit 3 is to the side or diagonally to the side of the operator. Specifically, the operation unit 3 is to the right of the driver 1 and is to the left of the passenger 2. FIG. 16, which is a schematic diagram, exaggerates the operation unit 3 as compared with the driver 1 and the passenger 2. FIG. 16 illustrates an exemplary arrangement in a vehicle with a left-hand steering wheel. Assuming that this apparatus is installed in a vehicle with a right-hand steering wheel, the person 2 is a driver and the person 1 is a passenger on the passenger seat.

Conventionally, the operation unit 3 has an operation reference direction 3a fixed in a front-rear direction (Y1-Y2) as illustrated in FIG. 16. As used herein, the “front-rear direction (Y1-Y2)” refers to the direction orthogonal to a direction (lateral direction: X1-X2), in which the driver 1 (the driver seat) and the passenger 2 (the passenger seat) are arranged laterally, in a plane. In other words, the “front-rear direction (Y1-Y2)” refers to the direction in which the vehicle moves forward or rearward. The “operation reference direction 3a” refers to a reference direction for operation on the operation unit 3.

The operation unit 3 is, for example, a touch panel. It is assumed that a plurality of representations (e.g., icons) 5a to 5d are displayed on an input operation surface 3b. In this case, the representations 5a to 5d are arranged in a matrix relative to the operation reference direction 3a so that the representations 5a to 5d can be readily seen when viewed in the front-rear direction (Y1-Y2).

Consequently, the representations 5a to 5d appear inclined when viewed from the driver 1 or the passenger 2. Disadvantageously, this results in a reduction in ease of operation with respect to the representations 5a to 5d.

Furthermore, it is assumed that the operator can enter characters on the input operation surface 3b. The longitudinal direction of a character to be entered is set to the operation reference direction 3a. For example, if the driver 1 enters the character “A” in an easy-to-write manner such that the character is inclined as illustrated in FIG. 16, the operation unit 3 may fail to correctly recognize the character “A” because the entered character “A” is inclined relative to the operation reference direction 3a. Unfortunately, this may cause an incorrect input or a wrong operation. Accordingly, the driver 1 has to turn his or her hand 4 so that the longitudinal direction (or direction from the fingertip to the wrist) of the hand 4 coincides with the front-rear direction (Y1-Y2), and then enter a character in such a manner that the longitudinal direction of the character coincides with the operation reference direction 3a as exactly as possible. In such a case, in particular, the driver 1 has to change his or her posture during driving in order to enter a character during driving. Disadvantageously, this results in a reduction in safety.

As described above, representations on such a conventional apparatus are difficult to see, thus causing an incorrect input or a wrong operation. The ease of operation of the conventional apparatus is low.

### SUMMARY

An input apparatus includes an operation unit and a controller configured to control an input operation to the operation unit. The controller includes a determination unit configured to determine whether the operation unit is going to be operated from, at least, a left side of the operation unit or a right side thereof, and a reference change unit configured to change an operation reference direction of the operation unit in plan view in accordance with a determination result of the determination unit.

As used herein, the term “operation reference direction” refers to a reference direction for operation on the operation unit. For example, the operation reference direction is the longitudinal direction of the operation unit to be operated by a hand or a finger. Conventionally, the operation reference direction has been fixed in a constant direction. Typically, the operation reference direction has been fixed in a front-rear direction orthogonal to a lateral direction in a plan.

According to the present invention, the determination unit determines whether the operation unit is going to be operated from the left side of the operation unit or the right side thereof. The reference change unit changes the operation reference direction of the operation unit in accordance with a determination result.

### BRIEF DESCRIPTION OF THE DRAWINGS

FIG. 1 is a schematic diagram illustrating part of a vehicle interior in which an input apparatus according to an embodiment is installed;

FIG. 2 is a schematic diagram illustrating a plan-view positional relationship between an operation unit in the embodiment, a driver, and a passenger on a passenger seat for explanation of, particularly, changing of an operation reference direction;

FIGS. 3A to 3C illustrate states in which a character has been entered on an input operation surface of the operation unit, FIG. 3A being a plan view of the operation unit for explanation of a first input mode, FIG. 3B being a plan view of the operation unit for explanation of a second input mode, FIG. 3C being a plan view of the operation unit for explanation of a third input mode;

FIGS. 4A to 4C illustrate states in which representations are displayed on the input operation surface of the operation unit, FIG. 4A being a plan view of the operation unit for explanation of the first input mode, FIG. 4B being a plan view of the operation unit for explanation of the second input mode, FIG. 4C being a plan view of the operation unit for explanation of the third input mode;

FIG. 5A is a plan view of the operation unit including a touch panel;

FIG. 5B is a side view of the operation unit of FIG. 5A;

FIG. 6 is a plan view of the operation unit including a rotary switch;

FIG. 7 is a plan view of the operation unit including a shifter;

FIG. 8A is a plan view illustrating the operation unit and sensors capable of detecting motion of an operating object, such as a hand, arranged on opposite sides of the operation unit;

FIG. 8B is a plan view illustrating the operation unit and a switch disposed near a side of the operation unit, the switch switching between operations;

FIG. 9 is a schematic diagram (plan view) for explanation of an operating direction of the operating object (hand) based on image information from a charge-coupled device (CCD) camera;

FIG. 10 is a schematic diagram (plan view) for explanation of an operating direction of the operating object (hand) different from the operating direction in FIG. 9 based on image information from the CCD camera;

FIG. 11 is a block diagram of the input apparatus according to the embodiment;

FIG. 12A is a flowchart of a process of obtaining image information from the CCD camera (imaging device) to change the operation reference direction of the operation unit;

FIG. 12B is a flowchart of a process of estimating motion of an operating object;

FIG. 12C is a flowchart of a process of estimating part, particularly, corresponding to a hand;

FIG. 13A is a schematic diagram illustrating the imaging device and an imaging range of the imaging device in side view;

FIG. 13B is a schematic diagram illustrating the imaging device and the imaging range of the imaging device in front view;

FIGS. 14A to 14D are schematic diagrams explaining the process of estimating part corresponding to a hand;

FIG. 15 is a schematic diagram explaining an algorithm for estimating the position of a finger; and

FIG. 16 is a schematic diagram illustrating a plan-view positional relationship between an operation unit, a driver, and a passenger on a passenger seat for explanation of disadvantages in related art.

### DESCRIPTION OF THE EXEMPLARY EMBODIMENTS

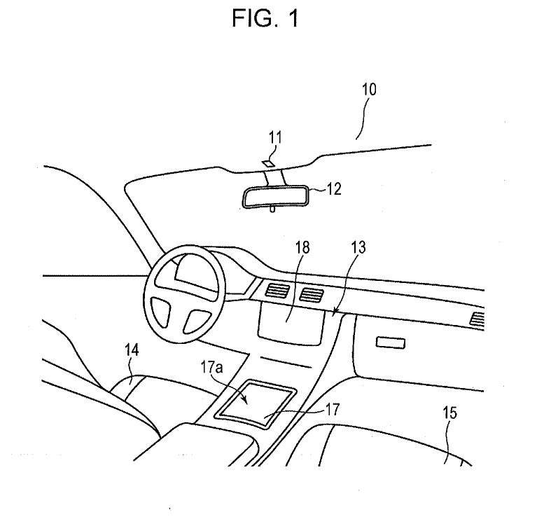

FIG. 1 illustrates front seats in a vehicle interior and their surroundings. Although FIG. 1 illustrates a vehicle with a left-hand steering wheel, an input apparatus according to an embodiment can be installed in a vehicle with a right-hand steering wheel.

Referring to FIG. 1, a CCD camera (imaging device) 11 is attached to a ceiling 10 in the vehicle interior. Although the CCD camera 11 is disposed near a rearview mirror 12, the CCD camera 11 may be disposed at any position where the CCD camera 11 captures an image including at least a central operation unit 17. The CCD camera 11 may be of any type and have any number of pixels. Although the embodiment uses the CCD camera 11, a camera capable of sensing infrared radiation may be used so that motion of an operating object can be detected during night-time.

Referring to FIG. 1, the central operation unit 17 is disposed between a driver seat 14 and a passenger seat 15. The central operation unit 17 and an operation panel 18 are provided for a center console 13.

The central operation unit 17 is, for example, a touch pad. The touch pad, which is of a capacitance type, for example, has a surface that serves as an input operation surface 17a. When the input operation surface 17a is operated by a finger or the like (operating object), an operation position can be determined based on a change in capacitance. The central operation unit 17 is operatively connected to the operation panel 18. The operation panel 18 may reflect an input to the central operation unit 17. The input operation surface 17a of the central operation unit 17 may be a touch panel that also functions as a display screen. As used herein, the term “touch panel” is defined as a device that functions as a touch pad and also functions as a display device. For example, the input operation surface 17a of the central operation unit 17 may display a representation of operation or control of a vehicle interior state, a representation of operation of music and/or video content, and a representation of operation of a portable device. Any of the representations can be selected as necessary by a finger or the like (operating object), thus activating a predetermined function, alternatively, obtaining necessary information.

The operation panel 18 is a capacitance touch panel, for example. The operation panel 18 is capable of displaying, for example, a map of a car navigation system and a music play screen. An operator can perform an input operation on the operation panel 18 by directly touching a screen of the operation panel 18 with his or her finger or the like.

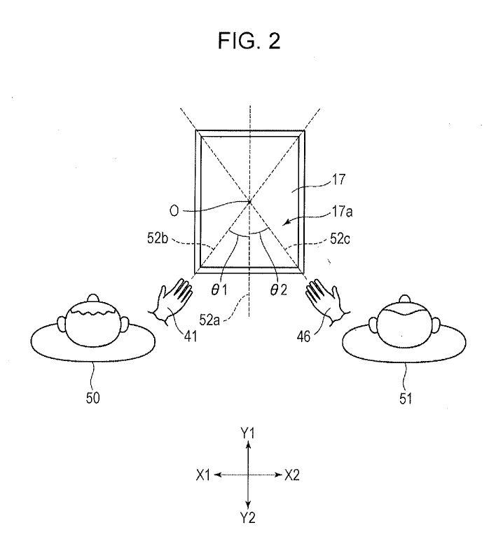

Control of an operation reference direction of the central operation unit 17 will now be described with reference to FIG. 2.

Referring to FIG. 2, a person 50 is a driver on the driver seat 14 (refer to FIG. 1) and a person 51 is a passenger on the passenger seat 15 (refer to FIG. 1). FIG. 2 exaggerates the central operation unit 17. FIG. 2 illustrates the central operation unit 17, the driver 50, and the passenger 51 in plan view from above. Although FIG. 2 illustrates an arrangement in the vehicle with the left-hand steering wheel, the input apparatus according to this embodiment may be installed in a vehicle with a right-hand steering wheel.

An X1-X2 direction in FIG. 2 refers to a lateral direction (transverse direction) in which the driver 50 (the driver seat 14) and the passenger 51 (the passenger seat 15) are arranged. A Y1-Y2 direction refers to a font-rear direction orthogonal to the lateral direction in a plane. Accordingly, a Y1 direction refers to a direction of forward movement of the vehicle and a Y2 direction refers to a direction of rearward movement thereof.

The operation reference direction is set in the central operation unit 17. As used herein, the term “operation reference direction” refers to a reference direction for operation on the central operation unit 17. For example, the operation reference direction is set to a longitudinal direction of operation on the central operation unit 17 with a hand or finger.

It is assumed that the operation reference direction, indicated at 52a, coincides with the front-rear direction (Y1-Y2). For example, the operation reference direction 52a can be set to the front-rear direction in an initial state (e.g., just after engine start). Alternatively, the operation reference direction 52a set previously can be held in the initial state (e.g., just after engine start). For convenience of description, it is assumed that the operation reference direction 52a in the initial state is the front-rear direction (Y1-Y2).

Such a state in which the operation reference direction 52a coincides with the front-rear direction (Y1-Y2) refers to a first input mode.

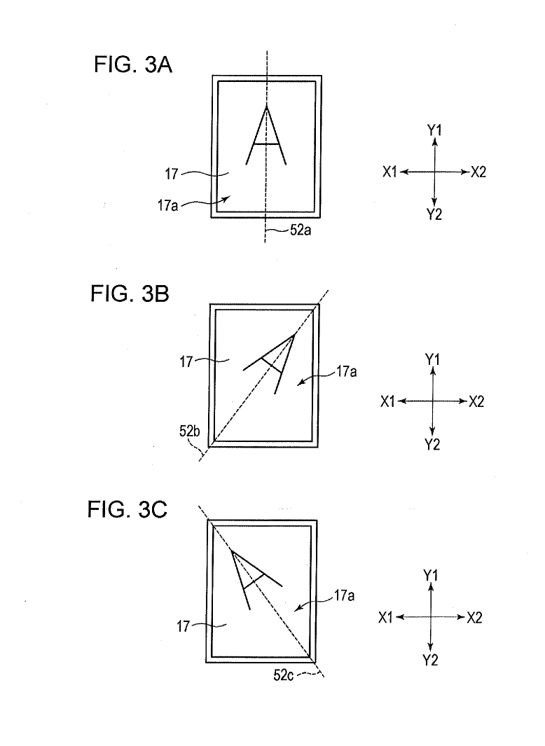

For example, a character can be entered on the input operation surface 17a of the central operation unit 17. Referring to FIG. 3A, the operation reference direction 52a coincides with the front-rear direction (Y1-Y2) of the central operation unit 17 in the first input mode. For example, when the character “A” is entered such that the longitudinal direction of the character coincides with the front-rear direction as illustrated in FIG. 3A, the central operation unit 17 recognizes the character “A”, so that a predetermined function can be activated in, for example, the vehicle interior, alternatively, input information can be transmitted to the operation panel 18 and a predetermined function can be activated on the operation panel 18.

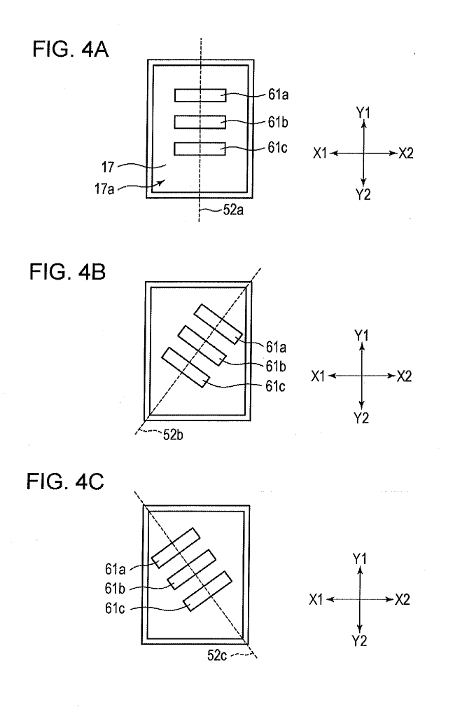

It is assumed that a plurality of icons 61a to 61c are displayed on the input operation surface 17a of the central operation unit 17 as illustrated in FIG. 4A. The icons 61a, 61b, and 61c are displayed such that the icons are arranged one above another in the operation reference direction 52a (front-rear direction) as illustrated in FIG. 4A. In this mode, the direction in which the icons 61a to 61c are arranged coincides with the operation reference direction 52a (front-rear direction). For example, when the operator operates the icon 61a, a predetermined function can be activated in the vehicle interior or the like, alternatively, input information can be transmitted to the operation panel 18 and a predetermined function can be activated on the operation panel 18.

It is assumed that the driver 50 is stretching out his or her hand 41 to operate the central operation unit 17 as illustrated in FIG. 2.

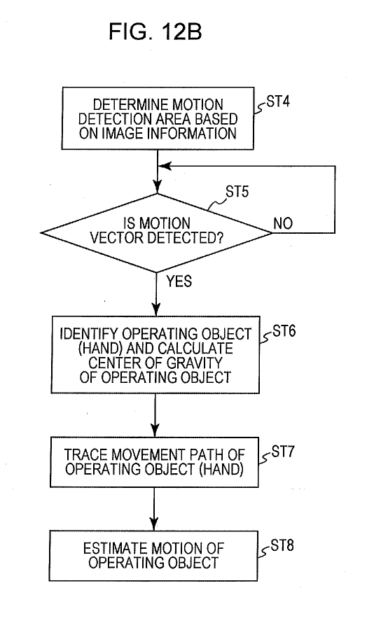

Whether the driver 50 is stretching out the hand 41 to operate the central operation unit 17 as described above, alternatively, whether the passenger 51 is stretching out his or her hand 46 to operate the central operation unit 17 can be determined based on image information from the CCD camera 11. The principle of determination based on image information will be described in detail later. In the embodiment, a controller 21 includes a determination unit 26 as will be described later. The configuration of the input apparatus will be described in detail with reference to a block diagram of FIG. 11.

When it is determined that the driver 50 is stretching out the hand 41 to operate the central operation unit 17, an operation reference direction 52b is inclined to the front-rear direction (Y1-Y2) of the central operation unit 17 in plan view so that the driver 50 readily operates the central operation unit 17. For example, as illustrated in FIG. 2, the operation reference direction 52b is rotated clockwise about the center, indicated at 0, of the input operation surface 17a of the central operation unit 17 by an angle θ1 (90° or less) relative to the front-rear direction (Y1-Y2). Such a state in which the operation reference direction 52b is inclined by the angle θ1 refers to a second input mode. In the embodiment, the controller 21 includes a reference change unit 27 for changing the operation reference direction 52a to the operation reference direction 52b. The configuration of the input apparatus will be described in detail later with reference to the block diagram of FIG. 11. As used herein, the term “plan view” refers to a view in a direction orthogonal to both the X1-X2 direction and the Y1-Y2 direction.

When it is determined that the central operation unit 17 is going to be operated by the driver 50 as described above, the operation reference direction 52b is inclined to the front-rear direction (operation reference direction 52a) in order to facilitate operation by the driver 50, thus changing the first input mode to the second input mode. In other words, the operation reference direction 52b can be inclined so as to substantially coincide with an operating direction of the driver 50. The angle θ1 (greater than 0° and equal to or less than 90°) may be a predetermined value to be used in accordance with a determination result indicating that the central operation unit 17 is going to be operated by the driver 50.

In the second input mode, when the character “A” is entered such that the longitudinal direction of the character coincides with the operation reference direction 52b inclined to the front-rear direction (Y1-Y2) as illustrated in FIG. 3B, the central operation unit 17 recognizes the character “A”, so that a predetermined function can be activated in the vehicle interior or the like, alternatively, input information can be transmitted to the operation panel 18 and a predetermined function can be activated on the operation panel 18.

As illustrated in FIG. 4B, the icons 61a to 61c are displayed such that the icons are arranged one above another in the operation reference direction 52b inclined to the front-rear direction (Y1-Y2). As described above, the operation reference direction 52a in FIG. 4A is changed to the operation reference direction 52b inclined to the front-rear direction (Y1-Y2) as illustrated in FIG. 4B, so that arrangement of the icons 61a to 61c is changed from a display pattern in FIG. 4A to another display pattern in FIG. 4B.

When it is determined that the passenger 51 is stretching out the hand 46 to operate the central operation unit 17 as illustrated in FIG. 2, an operation reference direction 52c is inclined to the front-rear direction (Y1-Y2) of the central operation unit 17 in plan view so that the passenger 51 readily operates the central operation unit 17. For example, as illustrated in FIG. 2, the operation reference direction 52c is rotated counterclockwise about the center O by an angle θ2 (greater than 0° and equal to or less than 90°) relative to the front-rear direction (Y1-Y2). Such a state in which the operation reference direction 52c is inclined by the angle θ2 (or inclined in a different direction from the operation reference direction 52b) refers to a third input mode.

When it is determined that the central operation unit 17 is going to be operated by the passenger 51 as described above, the operation reference direction 52c is inclined to the front-rear direction (operation reference direction 52a) to facilitate operation by the passenger 51. In other words, the operation reference direction 52c can be inclined so as to substantially coincide with an operating direction of the passenger 51. The angle θ2 may be a predetermined value to be used in accordance with a determination result indicating that the central operation unit 17 is going to be operated by the passenger 51. Preferably, the angles θ1 and O₂ have the same value.

In the third input mode, when the character “A” is entered such that the longitudinal direction of the character coincides with the operation reference direction 52c inclined to the front-rear direction (Y1-Y2) (or inclined in the different direction from the operation reference direction 52b) as illustrated in FIG. 3C, the central operation unit 17 recognizes the character “A”, so that a predetermined function can be activated in the vehicle interior or the like, alternatively, input information can be transmitted to the operation panel 18 and a predetermined function can be activated on the operation panel 18.

As illustrated in FIG. 4C, the icons 61a to 61c are displayed such that the icons are arranged one above another in the operation reference direction 52c inclined to the front-rear direction (Y1-Y2) (or inclined in the different direction from the operation reference direction 52b). As described above, the operation reference direction 52a in FIG. 4A is changed to the operation reference direction 52c inclined to the front-rear direction (Y1-Y2) as illustrated in FIG. 4C, so that the arrangement of the icons 61a to 61c is changed from the display pattern in FIG. 4A to another display pattern in FIG. 4C.

In a conventional input apparatus, the operation reference direction of the central operation unit 17 would be fixed in the front-rear direction (Y1-Y2). In other words, the operation reference direction 52a would be fixed. If an operator is located substantially in an extension in the operation reference direction 52a of the central operation unit 17, the operator could readily operate the input operation surface 17a of the central operation unit 17.

In the configuration in which the center console 13 is provided with the central operation unit 17, however, the driver 50 and the passenger 51 are laterally located on opposite sides of the central operation unit 17. If the operation reference direction is fixed in the front-rear direction (Y1-Y2) as in the conventional input apparatus, for example, the driver 50 would have to enter a character in such a manner that the longitudinal direction of the character coincides with the operation reference direction 52a, serving as the front-rear direction (Y1-Y2), as illustrated in FIG. 3A. The driver 50 would fail to enter the character unless the driver 50 turns the hand 41 so that the longitudinal direction of the hand 41 (or the direction from the fingertip to the wrist) coincides with the front-rear direction (Y1-Y2), alternatively, the driver 50 turns his or her arm so that the arm extends in the operation reference direction 52a. Specifically, if the operation reference direction 52a is the front-rear direction (Y1-Y2) and the character is entered at an angle as illustrated in FIG. 3B, the character could not be recognized, thus causing a wrong operation. The character would have to be re-entered, so that the driver 50 would have to operate the central operation unit 17 with an unnatural posture as described above. If the driver 50 turns the hand 41 (or the arm) above the central operation unit 17 to operate the central operation unit 17 during driving, the posture of the driver 50 would become imbalanced, which would endanger the driver's life.

According to this embodiment, whether the operator is the driver 50 or the passenger 51 is determined and the operation reference direction 52a is then appropriately changed to the operation reference direction 52b or 52c, as illustrated in FIG. 2, depending on a determination result.

This achieves greater ease of operation than the above-described conventional input apparatus. According to the embodiment, the driver 50 can perform an input operation without any unnatural posture, for example, turning his or her arm, thus achieving smooth operation. This results in effectively improved safety during driving as well as the ease of operation.

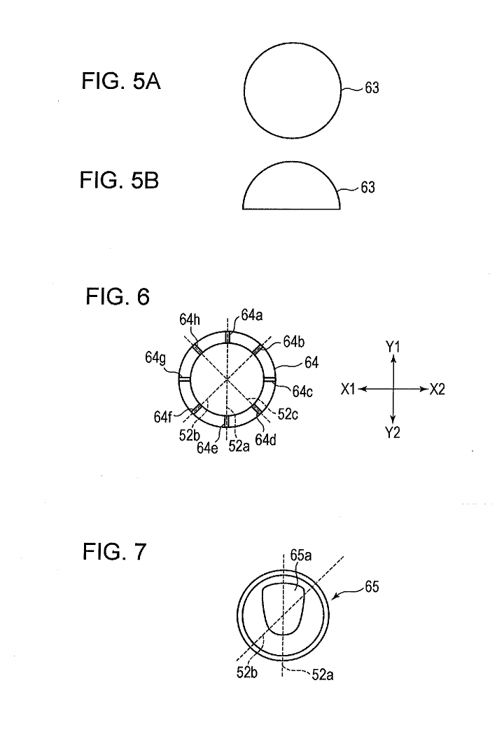

Although FIG. 2 illustrates the central operation unit 17, which is flat and rectangular, the central operation unit 17 may have any shape. For example, a substantially hemispherical central operation unit 63, as illustrated in FIGS. 5A and 5B, may be used. FIG. 5A is a plan view of the central operation unit 63 and FIG. 5B is a side view thereof. In the unit in three-dimensional form as illustrated in FIG. 5B, the operation reference direction can be changed in a plane of the central operation unit 63 in plan view of FIG. 5A. The central operation unit 63 may be a touch pad or a touch panel.

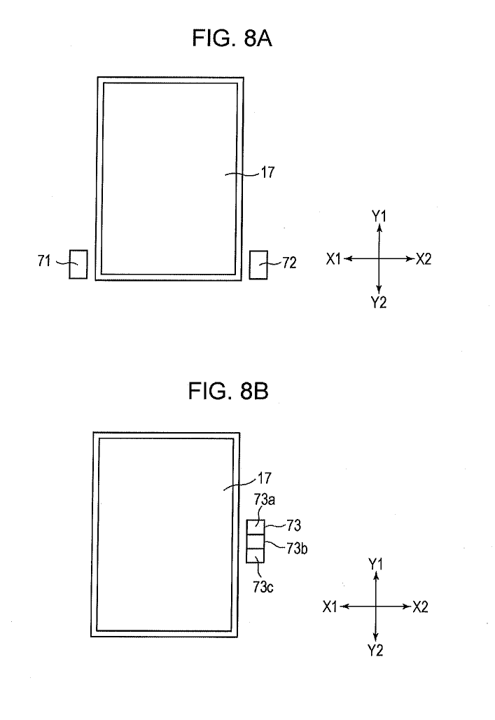

Alternatively, a central operation unit 64 may be a rotary switch as illustrated in FIG. 6. Referring to FIG. 6, the rotary switch has contacts 64a to 64h arranged in eight directions obtained by, for example, equally dividing its circumference (360°) into segments. When a rotating body is rotated, a terminal of the rotating body sequentially comes into contact with the contacts 64a to 64h such that eight outputs can be obtained in one rotation. In this case, it is assumed that the operation reference direction 52a that coincides with the front-rear direction (Y1-Y2) is a switch reference direction in the first input mode and the contacts are sequentially defined clockwise in the order from the first contact 64a. A first function is activated in response to an output from the first contact 64a. In the second input mode, the operation reference direction 52b inclined to the front-rear direction (Y1-Y2) is the switch reference direction and the first contact is changed to the contact 64b. Consequently, the first function can be activated in response to an output from the first contact 64b. The other contacts are similarly changed. In the third input mode, the operation reference direction 52c (different from the operation reference direction 52b) inclined to the front-rear direction (Y1-Y2) is the switch reference direction and the first contact is changed to the contact 64h. Consequently, the first function can be activated in response to an output from the first contact 64h. The other contacts are similarly changed. As described above, the relationship between functions and outputs from the contacts 64a to 64h of the rotary switch 64 that allows multiple inputs can be changed in accordance with the change of the operation reference direction (switch reference direction).

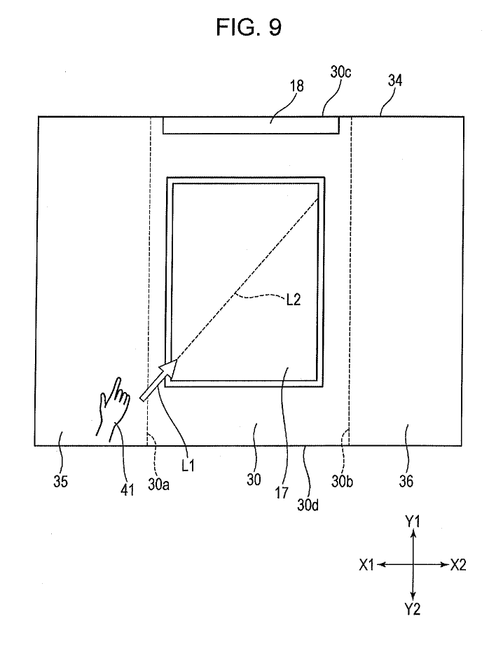

As illustrated in FIG. 7, a central operation unit 65 may be a shifter. In the first input mode, the operation reference direction 52a that coincides with the front-rear direction (Y1-Y2) is a shifter reference direction. An operating part 65a can be operated in accordance with the operation reference direction 52a (shifter reference direction). In the second input mode, the operation reference direction 52b inclined to the front-rear direction (Y1-Y2) is the shifter reference direction and the operating part 65a can be operated in accordance with the operation reference direction 52b (shifter reference direction). Since the third input mode is for the passenger 51, the third input mode is not suitable for the shifter. The third input mode is accordingly omitted. Whether the central operation unit is going to be operated by the driver 50 or the passenger 51 can also be determined in a modification illustrated in FIG. 7. For example, when it is determined that the central operation unit is going to be operated by the driver 50, the operation reference direction is changed. When it is determined that the central operation unit is going to be operated by the passenger 51, the operation reference direction may be maintained in the front-rear direction (Y1-Y2), alternatively, the operation reference direction 52b based on a previous determination result may be maintained.

Furthermore, another mode in which a predetermined operation reference direction is maintained if the operator is changed to another operator may be used. Specifically, a first mode in which the operation reference direction can be changed in response to the change of the operator and a second mode in which the predetermined operation reference direction is maintained if the operator is changed to another operator may be provided. The operator can select either of these modes.

If it is difficult to determine an operating direction relative to the central operation unit 17, for example, if both the driver 50 and the passenger 51 stretch out their hands 41 and 46 to operate the central operation unit 17 at the same time and it is difficult to determine the priority order of the driver 50 and the passenger 51, the operating direction would be indeterminable. In this case, control can be performed such that the operation reference direction based on a previous determination result is maintained. For example, assuming that the operation reference direction based on the previous determination result is the operation reference direction 52b illustrated in FIG. 4B, if the operating direction is indeterminable, the operation reference direction 52b may be maintained. Since the operation reference direction 52b is maintained in this manner, it is unnecessary to calculate a new operation reference direction, thus reducing a load on the controller. Furthermore, the operation reference direction based on the previous determination result may be maintained as long as the determination result is unchanged. For example, assuming that the operation reference direction based on the previous determination result is the operation reference direction 52b in FIG. 4B, the operation reference direction 52b may be continuously maintained until it is determined that the operator is not the driver 50. For example, assuming that the operation reference direction 52a that coincides with the front-rear direction (Y1-Y2) in FIG. 4A is set as a default direction, the operation reference direction may be returned to the default direction after a certain period of time. Alternatively, the operation reference direction based on the previous determination result may be maintained, thus reducing a load on the controller.

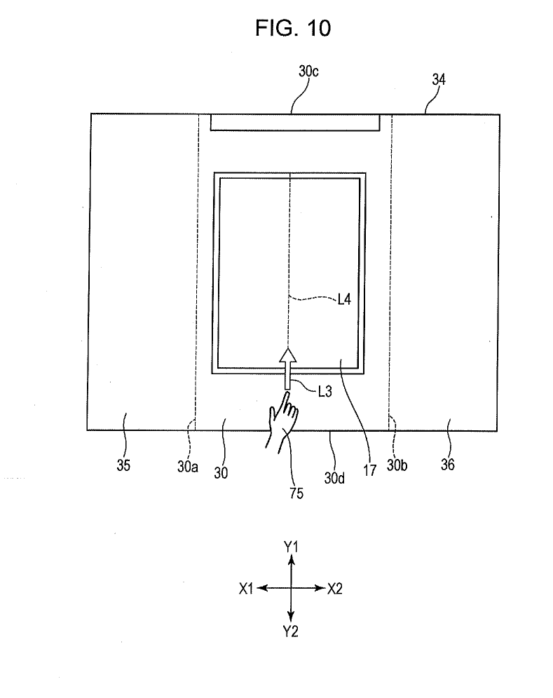

Which direction the central operation unit 17 is going to be operated in can be determined using the CCD camera 11 illustrated in FIG. 1 and an operating direction can be determined based on image information from the CCD camera 11. For example, a sensor 71 and a sensor 72 that are capable of detecting motion of an operating object may be disposed on left and right sides of the central operation unit 17 in the X1-X2 direction, respectively, as illustrated in FIG. 8A. The sensor 71 can detect motion of the hand (operating object) 41 of the driver 50 in FIG. 2. The sensor 72 can detect motion of the hand (operating object) 46 of the passenger 51 in FIG. 2. As described above, it is only required that whether the central operation unit 17 is going to be operated from, at least, the left side of the central operation unit 17 or the right side thereof is determined by using the sensors 71 and 72. The sensors 71 and 72 may have any configuration. For example, the sensors 71 and 72 may be optical sensors, pyroelectric sensors, or capacitance sensors.

When the sensor 71 detects motion of the operating object, the operation reference direction is changed to the operation reference direction 52b in FIG. 2. On the other hand, when the sensor 72 detects motion of the operating object, the operation reference direction is changed to the operation reference direction 52c in FIG. 2.

Alternatively, as illustrated in FIG. 8B, a switch 73 capable of switching between operation by the driver 50 and operation by the passenger 51 may be disposed near the central operation unit 17. For example, when a first press portion 73a of the switch 73 is pressed, it is determined that the central operation unit 17 is going to be operated by the driver 50, so that the operation reference direction is changed to the operation reference direction 52b in FIG. 2. When a second press portion 73b of the switch 73 is pressed, it is determined that the central operation unit 17 is going to be operated by the passenger 51, so that the operation reference direction is changed to the operation reference direction 52c in FIG. 2. When a third press portion 73c of the switch 73 is pressed, the operation reference direction is changed or returned to the operation reference direction 52a in FIG. 2.

The configuration of the input apparatus, indicated at 20, will now be described in detail. The input apparatus 20 determines an operating direction relative to the central operation unit 17 based on image information from the CCD camera 11 in FIG. 1 and controls the operation reference direction of the central operation unit 17 in accordance with a determination result.

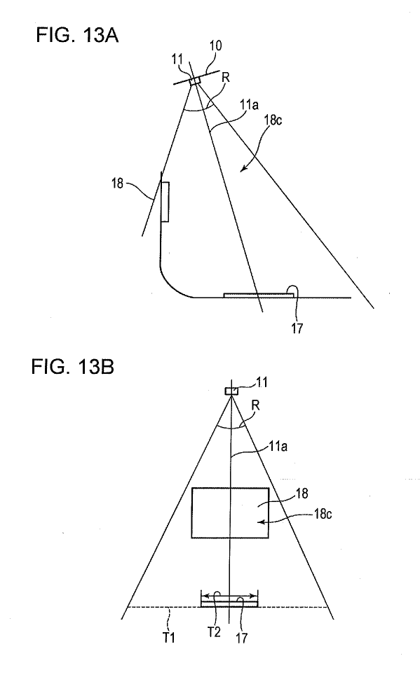

As illustrated in FIG. 13A, the CCD camera 11 attached to the ceiling 10 is positioned so as to capture an image including at least the central operation unit 17 disposed in front of the operation panel 18.

In FIGS. 13A and 13B, the CCD camera 11 has a central axis (optical axis) 11a and has an imaging range R.

FIG. 13A illustrates a side view of the imaging range R. In FIG. 13A, the operation panel 18 and a space area 18c in front of the operation panel 18 are located in the imaging range R. The central operation unit 17 is located in the space area 18c. FIG. 13B illustrates a front view of the imaging range R. In FIG. 13B, the imaging range R has a width (maximum width of an image to be captured) T1, which is greater than the width, T2, of the central operation unit 17.

As illustrated in FIG. 11, the input apparatus 20 according to the embodiment includes the CCD camera (imaging device) 11, the central operation unit 17, the operation panel 18, and the controller 21.

With reference to FIG. 11, the controller 21 includes an image information detection unit 22, a calculation unit 24, a motion estimation unit 25, the determination unit 26, and the reference change unit 27.

FIG. 11 illustrates the controller 21 as a single component. For example, a plurality of controllers 21 may be provided and the image information detection unit 22, the calculation unit 24, the motion estimation unit 25, the determination unit 26, and the reference change unit 27 illustrated in FIG. 11 may be separated and incorporated in the controllers.

In other words, how to incorporate the image information detection unit 22, the calculation unit 24, the motion estimation unit 25, the determination unit 26, and the reference change unit 27 into the controllers can be appropriately selected.

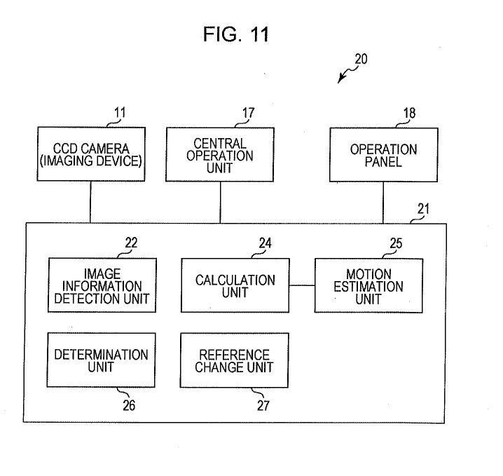

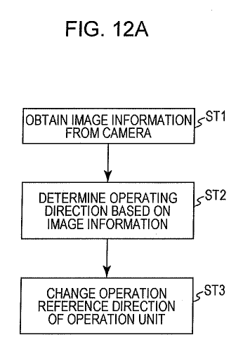

The image information detection unit 22 obtains image information about an image captured by the CCD camera 11. The term “image information” refers to electronic information about an image captured by imaging. FIGS. 9 and 10 illustrate images 34 captured by the CCD camera 11.

The calculation unit 24 in FIG. 11 is a component for calculating a moving direction of an operating object. For example, a movement path of the operating object can be calculated in the embodiment. Any method of calculation may be used. For example, the movement path of the operating object can be calculated using the following method.

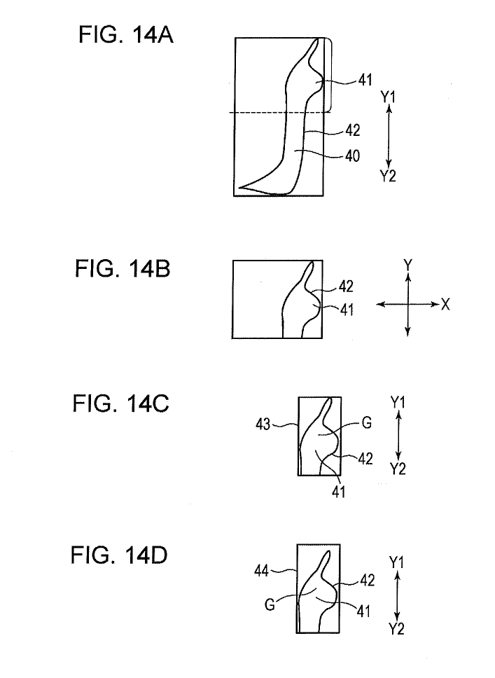

Referring to FIG. 14A, information about a contour 42 including contour part of an arm 40 and contour part of the hand 41 is detected. To obtain the contour 42, an image captured by the CCD camera 11 is reduced in size to reduce the amount of calculation and, after that, the resultant image is subjected to monochrome conversion for recognition. In this case, the operating object can be accurately recognized by using a detailed image. According to the embodiment, a reduction in the size of an image allows a reduction in the amount of calculation, thus facilitating ready processing. Then, the operating object is detected based on a change in brightness of the image subjected to the monochrome conversion. If an infrared-sensitive camera is used, monochrome conversion for an image can be omitted. After that, optical flow is calculated using, for example, the preceding frame and the current frame, thereby detecting motion vectors. At this time, the motion vectors are averaged with 2×2 pixels to reduce the influence of noise. When the motion vectors have a predetermined length (movement distance) or more, the contour 42 including the contour part of the arm 40 and that of the hand 41 in a motion detection area 30 is detected as an operating object as illustrated in FIG. 14A.

Then, the length (Y1-Y2) of the image is limited as illustrated in FIG. 14A and an image is cut out in order to estimate a region of the hand 41 as illustrated in FIG. 4B. At this time, the size of each of parts of the operating object is calculated based on the contour 42. A region having a predetermined value or more is determined as a valid region. The reason why a lower limit is defined is that the arm is excluded based on the fact that the hand is typically wider than the arm. In addition, the reason why an upper limit is not defined is as follows. If a captured image includes an operator's body in the motion detection area 30, motion vectors will be generated in a large area. Accordingly, if the upper limit is defined, the motion vectors may fail to be detected. Then, a region surrounding the contour 42 is detected in the valid region. For example, X and Y coordinates included in the entire contour 42 are determined in FIG. 14B and a minimum value and a maximum value of the X coordinates are then obtained. The width (dimension in the X direction) of the valid region is reduced as illustrated in FIG. 14C. A minimum rectangular region 43 surrounding the contour 42 is detected in that manner. Whether the length (Y1-Y2) of the minimum rectangular region (valid region) 43 is less than or equal to a predetermined threshold value is determined. When the length of the minimum rectangular region 43 is less than or equal to the predetermined threshold value, the center of gravity G in the valid region is calculated.

When the length (in the Y1-Y2 direction) of the minimum rectangular region (valid region) 43 is greater than the predetermined threshold value, the length is limited to the above-described lower limit in a predetermined distance range extending from the side in the Y1 direction, so that an image is cut out (refer to FIG. 14D). Furthermore, a minimum rectangular region 44 surrounding the contour 42 is detected in the cut-out image. The minimum rectangular region 44 is enlarged in all directions by several pixels, thus obtaining a region (hereinafter, referred to as a “hand estimation region”) estimated to include a hand image. Since the enlarged region is used as the hand estimation region, part corresponding to the hand 41 excluded accidentally in the detection of the contour 42 can be again recognized. The above-described determination concerning the valid region in the hand estimation region is made. When the length of the valid region is less than or equal to the predetermined threshold value, the middle of the valid region is defined as the center of gravity G of the hand 41. The method of calculation of the center of gravity G is not limited to the above-described one. The center of gravity G can be obtained using an existing algorithm. Motion estimation of an operating object during driving a vehicle requires rapid calculation of the center of gravity G, and it is unnecessary to calculate the center of gravity G with significantly high accuracy. It is important to successively calculate a motion vector of, in particular, a position defined as the center of gravity G. The use of the motion vector enables reliable motion estimation if it is difficult to determine the shape of a hand, serving as an operating object, under a situation where, for example, an ambient illumination state sequentially changes. In the above-described process, the hand and the arm can be reliably distinguished from each other by using two information items, i.e., information about the contour 42 and information about the region surrounding the contour 42.

During detection of the above-described motion vectors, a movement vector of the center of gravity G of a moving object (in this case, the hand 41) is calculated. The movement vector of the center of gravity G can be obtained as a movement path of the moving object.

The motion estimation unit 25 in FIG. 11 estimates a position that the operating object will reach and a direction in which the operating object will move in accordance with the movement path of the operating object. For example, the motion estimation unit 25 estimates whether a movement path L1 of the hand 41 will extend in a diagonal direction (operating direction L2 indicated by a dashed line) between the Y1 direction and an X2 direction above the central operation unit 17 as illustrated in FIG. 9, alternatively, whether a movement path L3 of a hand 75 will extend in the Y1 direction (operating direction L4 indicated by a dashed line) above the central operation unit 17 as illustrated in FIG. 10.

The determination unit 26 in FIG. 11 determines an operating direction of the operating object relative to the central operation unit 17 based on image information. In the embodiment, as described above, whether the central operation unit 17 is going to be operated from the left side of the central operation unit 17 or the right side thereof can be determined by detecting the movement path as the movement vector of the center of gravity G of a hand, serving as an operating object. The determination unit 26 can make a determination based on the movement path (moving direction) L1 or L3 of the hand (operating object) or the operating direction L2 or L4 based on motion estimation in FIGS. 9 and 10.

In FIG. 8A, the determination unit 26 corresponds to the sensors 71 and 72. In FIG. 8B, the determination unit 26 corresponds to the switch 73. If the sensors 71 and 72 or the switch 73 is used as the determination unit 26, the CCD camera 11, the image information detection unit 22, the calculation unit 24, and the motion estimation unit 25 in FIG. 11 may be eliminated or remain.

The reference change unit 27 in FIG. 11 appropriately changes the operation reference direction of the central operation unit 17 in accordance with a determination result of the determination unit 26. For example, the operation reference direction is allowed to coincide with the operating direction L2 in FIG. 9 or the operating direction L4 in FIG. 10. Allowing the operation reference direction to coincide with the operating direction as described above further increases the ease of operation.

Alternatively, the reference change unit 27 may select a proper operation reference direction from a plurality of operation reference directions stored previously in accordance with a determination result of the determination unit 26. For example, it is assumed that the operation reference directions 52a, 52b, and 52c illustrated in FIG. 2 are stored in the controller 21. When the determination unit 26 determines that the central operation unit 17 is going to be operated from the left side of the central operation unit 17, the reference change unit 27 can select the operation reference direction 52b. When the determination unit 26 determines that the central operation unit 17 is going to be operated from the right side of the central operation unit 17, the reference change unit 27 can select the operation reference direction 52c. More different operation reference directions may be stored and the reference change unit 27 can select an operation reference direction close to, for example, the movement path L1 of the hand 41 or the operating direction L2 based on motion estimation in FIG. 9.

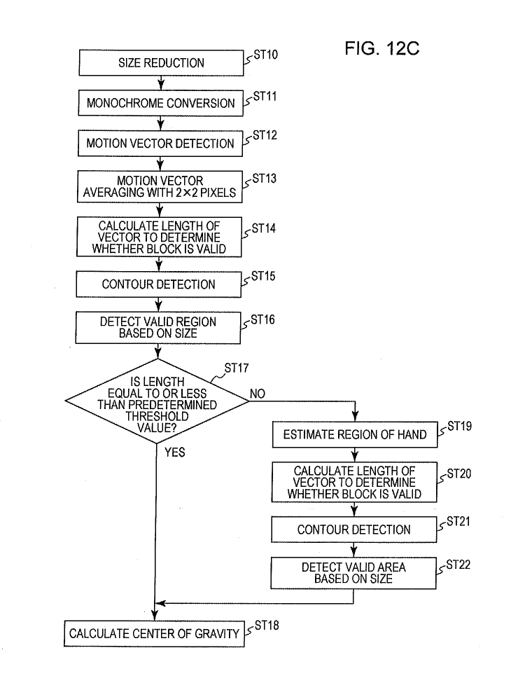

A process of obtaining image information to change the operation reference direction will now be described with reference to a flowchart of FIG. 12A. FIG. 12A illustrates main steps performed in the input apparatus 20 in FIG. 11. Substeps will be described with reference to FIGS. 12B and 12C.

In step ST1 in FIG. 12A, the image information detection unit 22 in FIG. 11 obtains image information from the CCD camera 11. In step ST2, the determination unit 26 determines an operating direction relative to the central operation unit 17 based on the image information. Specifically, the determination unit 26 can determine based on the movement path L1 or the operating direction L2 based on motion estimation in FIG. 9 that the central operation unit 17 is going to be operated from the left side of the central operation unit 17 by the hand 41, serving as an operating object. Similarly, the determination unit 26 can determine that the central operation unit 17 is going to be operated from the right side of the central operation unit 17, alternatively, that the central operation unit 17 is going to be operated in a rear-to-front direction (refer to FIG. 10) of the central operation unit 17.

In step ST3, the reference change unit 27 changes the operation reference direction of the central operation unit 17 in accordance with a determination result of the determination unit 26 in step ST2. Assuming that the operation reference direction is the operation reference direction 52a that coincides with the front-rear direction (Y1-Y2) in FIG. 2, when it is determined that the central operation unit 17 is going to be operated from the left side of the central operation unit 17, the reference change unit 27 changes the operation reference direction 52a to the operation reference direction 52b. When it is determined that the central operation unit 17 is going to be operated from the right side of the central operation unit 17, the reference change unit 27 changes the operation reference direction 52a to the operation reference direction 52c. If the determination unit 26 fails to make a determination, for example, if the driver 50 and the passenger 51 are stretching out their hands 41 and 46 over the central operation unit 17 to operate the central operation unit 17 at the same time, an operation by the driver 50 may be assigned priority, alternatively, the operation reference direction based on a previous determination result may be maintained. Alternatively, assuming that the operation reference direction 52a that coincides with the front-rear direction is a default direction, the operation reference direction can be returned to the default direction after a predetermined period of time.

After the operation reference direction is appropriately changed in step ST3, display or input is controlled in accordance with the changed operation reference direction as described with reference to FIGS. 3 and 4. In addition, the switch reference direction in FIG. 6 or the shifter reference direction in FIG. 7 can be changed. The operation panel 18 displays information or a representation based on an operation signal from the central operation unit 17.

In the configuration with the sensors 71 and 72 in FIG. 8A or the configuration with the switch 73 in FIG. 8B, step ST1 in FIG. 12A is omitted. In step ST2, whether the central operation unit 17 is going to be operated from, at least, the left side of the central operation unit 17 or the right side thereof can be determined by the sensors 71 and 72 (the determination unit) or the switch 73 (the determination unit). In step ST3 in FIG. 12A, the operation reference direction is appropriately changed in accordance with the result of determination.

Substeps performed between steps ST1 and ST2 in FIG. 12A will now be described with reference to FIGS. 12B and 12C.

In substep ST4 in FIG. 12B, the controller 21 in

FIG. 11 determines the motion detection area 30 based on image information detected by the image information detection unit 22. The motion detection area 30 is defined by a plurality of sides 30a, 30b, 30c, and 30d as illustrated in FIG. 9. A left area 35 and a right area 36 are excluded from the motion detection area 30. Referring to FIG. 9, the boundary (side) 30a between the left area 35 and the motion detection area 30 and the boundary (side) 30b between the motion detection area 30 and the right area 36 are indicated by dashed lines. Although FIG. 9 illustrates the sides 30c and 30d serve as edges of the image 34 in the front-rear direction, the sides 30c and 30d may be located inside the image 34.

The motion detection area 30 may be the entire image 34 in FIG. 9. In this case, the amount of calculation for tracking of the movement path of the operating object and motion estimation of the operating object would increase, leading to delay in the motion estimation or a reduction in life of the apparatus. Processing a large amount of calculation leads to an increase in manufacturing cost. It is therefore preferred that the entire image 34 be not used and a limited range be used as the motion detection area 30.

In substep ST5 in FIG. 12B, the calculation unit 24 in FIG. 11 detects motion vectors. Although motion vector detection is described with reference to substep ST5 in FIG. 12B, the presence or absence of a motion vector between the preceding frame and the current frame is detected at all times.

In substep ST6 in FIG. 12B, the operating object (hand) is identified as illustrated in FIGS. 14A to 14D and the center of gravity G of the operating object (hand) is calculated by the calculation unit 24 in FIG. 11.

In the embodiment, a hand is identified as an operating object as illustrated in FIGS. 14A to 14D. FIG. 12C illustrates a flowchart of a process (substep ST6) of estimating part corresponding to a hand to obtain the center of gravity G of the hand.

Referring to FIG. 12C, after the image information is obtained from the CCD camera 11 in FIG. 12A, the size of the image is reduced in subsubstep ST10. Then, the resultant image is subjected to monochrome conversion for recognition in subsubstep ST11. In subsubstep ST12, optical flow is calculated using, for example, the preceding frame and the current frame, thus detecting motion vectors. The motion vector detection is illustrated in substep ST5 in FIG. 12B as well as in subsubstep ST12. In FIG. 12C, it is assumed that the motion vectors are detected in subsubstep ST12. The process proceeds to subsubstep ST13.

In subsubstep ST13, the motion vectors are averaged using 2×2 pixels. For example, 80×60 blocks are obtained at this time.

In subsubstep ST14, the length (movement distance) of the vector is calculated for each block. When the vector length is greater than a predetermined value, the block is determined as valid for movement.

Then, the contour 42 of the operating object is detected as illustrated in FIG. 14A (subsubstep ST15).

In subsubstep ST16, the size of each of parts of the operating object is calculated based on the contour 42. A region having a predetermined value or more is determined as a valid region. A region surrounding the contour 42 is detected in the valid region. As described with reference to FIG. 14B, for example, the X and Y coordinates included in the entire contour 42 are determined, the minimum and maximum X coordinates are obtained, and the width (or the dimension in the X direction) of the valid region is reduced based on the minimum and maximum X coordinates as illustrated in FIG. 14C.

The minimum rectangular region 43 surrounding the contour 42 is detected in that manner. In subsubstep ST17, whether the length (in the Y1-Y2 direction) of the minimum rectangular region (valid region) 43 is less than or equal to the predetermined threshold value is determined. If YES in subsubstep ST17, the process proceeds to subsubstep ST18. In subsubstep ST18, the center of gravity G of the valid region is calculated.

When it is determined in subsubstep ST17 that the length (in the Y1-Y2 direction) of the minimum rectangular region 43 is greater than the predetermined threshold value, the length is limited to the above-described lower limit in the predetermined distance range extending from the side in the Y1 direction and an image is cut out (refer to FIG. 14D). In subsubstep ST19, the minimum rectangular region 44 surrounding the contour 42 is detected in the cut-out image and the minimum rectangular region 44 is enlarged in all directions by several pixels. The resultant region is used as a hand estimation region.

In subsubsteps ST20 to ST22, the above-described hand estimation region is subjected to the same processing as that in subsubsteps ST14 to ST16. After that, the middle of the valid region is defined as the center of gravity G in subsubstep ST18.

After the above-described calculation of the center of gravity G of the operating object (hand), the movement path of the operating object (hand) is traced in substep ST7 in FIG. 12B. The movement path can be traced based on the movement vector of the center of gravity G. As used herein, the term “tracing” refers to continuously following motion of the hand, which has entered the motion detection area 30. As described above, the movement path can be traced based on the movement vector of the center of gravity G of the hand. Since the center of gravity G is obtained at the time, for example, when optical flow is calculated using the preceding frame and the current frame to detect motion vectors, information items indicating the center of gravity G are obtained at time intervals. These time intervals to obtain the center of gravity G are included in “tracing” in the embodiment.

FIG. 9 illustrates a state in which the driver 50 extends the hand 41 toward the motion detection area 30 to operate the central operation unit 17.

In FIG. 9, an open arrow indicates the movement path L of the hand 41 in the motion detection area 30.

In substep ST8 in FIG. 12B, motion of the hand (operating object) 41 is estimated based on the movement path L1. Specifically, when the movement path L1 is maintained as it is, the motion estimation unit 25 in FIG. 11 estimates how the hand 41 will move over the central operation unit 17. Additionally, whether the operation is an operation to the central operation unit 17 or an operation to the operation panel 18 can be determined based on the motion estimation. When the operation to the central operation unit 17 is determined, various actions can be performed in accordance with the result of determination. For example, the screen, which is normally in an OFF mode, of the central operation unit 17 can be illuminated with light in accordance with the determination result.

In step ST2 in FIG. 12A, it can be determined, based on the movement path L1 of the hand 41 in FIG. 9 or the operating direction L2 of the hand 41 based on motion estimation, that the central operation unit 17 is going to be operated from the left side of the central operation unit 17. On the other hand, when the passenger 51 stretches out the hand 46 to operate the central operation unit 17 as illustrated in FIG. 2, it can be determined, based on the movement path of the hand 46 or the operating direction of the hand 46 based on motion estimation, that the central operation unit 17 is going to be operated from the right side of the central operation unit 17.

In the embodiment, the level of the operating object can also be calculated. Any method of calculation may be used. For example, the level of the hand 41 can be estimated based on the size of the minimum rectangular region 43 or 44 that includes the contour 42 of the hand 41 in FIG. 14C or 14D. As illustrated in FIG. 9, the image 34 captured by the CCD camera 11 is a plan view image. The CCD camera 11 provides plan view image information. The level of the hand 41 can be determined based on the assumption that the hand 41 is located higher (or closer to the CCD camera 11) as the area of the minimum rectangular region 43 or 44 is larger. In this case, initialization for reference size measurement is performed in order to calculate the level of the hand 41 based on a change in area of the hand 41 relative to a reference size of the hand 41 (for example, the size of the hand 41 operating the middle of the operation panel 18). Consequently, the level of the movement path of the hand 41 can be estimated. When the hand 41 is smaller than the above-described reference size, it can be determined that the operation is not an operation to the operation panel 18, namely, the operation can be recognized as an operation to the central operation unit 17.

In step ST2 in FIG. 12A in the embodiment, for example, when it is determined based on the movement path L3 of the hand 75 illustrated in FIG. 10 that the central operation unit 17 is going to be operated by the operating object extending from a backseat, the operation to the central operation unit 17 can be disabled or restricted. This improves safety.

Alternatively, when it is determined that the driver 50 is going to operate the central operation unit 17, the operation to the central operation unit 17 can be disabled or restricted. For example, while the vehicle travels at a predetermined speed or more, control may be performed so that the operation to the central operation unit 17 by the driver 50 is restricted or disabled.

As described above, the controller 21 can appropriately control an operation to the central operation unit 17 depending on the operator, namely, the driver 50, the passenger 51, or a passenger on the backseat. Furthermore, a mode in which an operation is restricted or disabled may be provided. The operator may appropriately select execution of this mode.

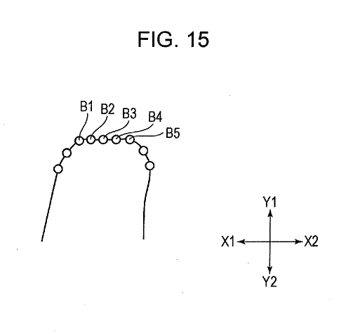

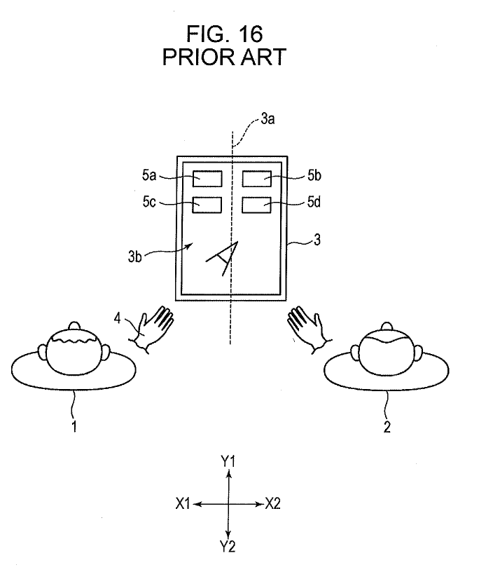

FIG. 15 illustrates a method of detecting a finger. The coordinates of the contour 42 of the hand 41 in FIG. 14B are obtained. As illustrated in FIG. 15, points B1 to B5 located farthest in the Y1 direction are selected. Since the Y1 direction is toward the operation panel 18, the points B1 to B5 farthest in the Y1 direction are estimated as a fingertip. The point B1 farthest in an X1 direction and the point B5 farthest in the X2 direction are obtained from the points B1 to B5. The coordinates of the midpoint (in this case, the position of the point B3) between the points B1 and B5 are estimated as a finger position. In the embodiment, the operating object may be a finger. Control may also be performed so that motion of the finger is estimated by tracing a movement path of the finger. The use of the movement path of the finger allows more detailed motion estimation.

In addition, discrimination between a left hand and a right hand or between the palm and the back of a hand may be performed.

Furthermore, if the operating object is in a stopped state in the motion detection area 30, the stopped state may be obtained based on the vector of the center of gravity G at all times, alternatively, the center of gravity G in the stopped state may be held for a predetermined period of time. Consequently, when the operating object starts moving, the movement path of the operating object can be immediately traced.

The input apparatus 20 according to the embodiment includes the central operation unit 17 and the controller 21 for controlling an input operation to the central operation unit 17. The controller 21 includes the determination unit 26 that determines whether the central operation unit 17 is going to be operated from, at least, the left side of the operation unit or the right side thereof and the reference change unit 27 that changes the operation reference direction of the central operation unit 17 in plan view in accordance with a determination result of the determination unit 26.

Conventionally, the operation reference direction has been fixed in a constant direction. Typically, the operation reference direction has been fixed in the front-rear direction orthogonal to the lateral direction in a plane.

According to the embodiment, the determination unit 26 determines whether the central operation unit 17 is going to be operated from either the left side of the central operation unit 17 or the right side thereof and the reference change unit 27 changes the operation reference direction of the central operation unit 17 in accordance with a determination result of the determination unit 26.

Consequently, the operation reference direction for an operation to the central operation unit 17 from the left side thereof can be made different from the operation reference direction for an operation to the central operation unit 17 from the right side thereof in the embodiment. As described above, the operation reference direction of the central operation unit 17 can be appropriately changed depending on an operating direction relative to the central operation unit 17, thus increasing the ease of operation.

The input apparatus 20 in the embodiment is intended to be used inside a vehicle, for example. An operating direction relative to the central operation unit 17 can be appropriately and readily determined based on image information from the CCD camera (imaging device) 11 attached to the vehicle interior. Consequently, the operation reference direction can be smoothly changed, thus increasing the ease of operation.

As regards a determination by the determination unit 26, the operating direction can be smoothly determined based on vector information concerning an operating object.

As described above, motion of the operating object can be estimated using image information. The determination unit 26 can more readily make a determination based on motion estimation, thus increasing the ease of operation.

The reference change unit 27 allows the operation reference direction to coincide with the operating direction of the operating object. For example, the operation reference direction is allowed to coincide with the operating direction L2 of the hand 41 in FIG. 9. Thus, the ease of operation can be more effectively increased.

Although the input apparatus 20 according to the embodiment is not limited to being mounted on a vehicle, the input apparatus 20 mounted on and used in a vehicle allows the determination unit 26 in the controller 21 to determine whether the central operation unit 17 is going to be operated by, at least, the driver 50 or the passenger 51, so that the operation reference direction can be appropriately changed depending on the operator. This provides improved safety during driving as well as comfort of operation.

What is claimed is:

1. An input apparatus comprising:
an operation unit; and
a controller configured to control an input operation to the operation unit, the controller including:
a determination unit configured to determine whether the operation unit is going to be operated from, at least, a left side of the operation unit or a right side thereof, and
a reference change unit configured to change an operation reference direction of the operation unit in plan view in accordance with a determination result of the determination unit.

2. The apparatus according to claim 1, wherein the reference change unit changes a direction in which the operation reference direction is inclined to a front-rear direction of the operation unit in accordance with the determination result.

3. The apparatus according to claim 1, wherein the reference change unit maintains the operation reference direction obtained in accordance with a previous determination result as long as the determination result of the determination unit is unchanged, alternatively, when the determination unit fails to make a, determination.

4. The apparatus according to claim 1, wherein the input apparatus has a first input mode in which the operation reference direction coincides with the front-rear direction of the operation unit, a second input mode in which the operation reference direction is changed to a direction different from the operation reference direction in the first input mode in accordance with a determination result indicating that the operation unit is going to be operated from the left side of the operation unit, and a third input mode in which the operation reference direction is changed to another direction different from the operation reference directions in the first and second input modes in accordance with a determination result indicating that the operation unit is going to be operated from the right side of the operation unit.

5. The apparatus according to claim 1, further comprising:
an imaging device that captures a plan view image of the operation unit,
wherein the determination unit makes a determination based on image information from the imaging device.

6. The apparatus according to claim 5, wherein the determination unit makes a determination based on vector information concerning an operating object.

7. The apparatus according to claim 5, wherein motion estimation of an operating object is enabled based on the image information and the determination unit makes a determination based on the motion estimation.

8. The apparatus according to claim 5, wherein the reference change unit allows the operation reference direction to coincide with an operating direction of an operating object.

9. The apparatus according to claim 1, further comprising:
a sensor that detects motion of an operating object,
wherein the determination unit makes a determination based on a detection result of the sensor.

10. The apparatus according to claim 1, further comprising:
a switch that switches between operation from the left side of the operation unit and operation from the right side thereof,
wherein the determination unit makes a determination based on a switching state of the switch.

11. The apparatus according to claim 1, wherein the operation unit is disposed inside a vehicle.

12. The apparatus according to claim 11,
wherein the operation unit is disposed between a driver seat and a passenger seat arranged laterally, and
wherein the determination unit determines whether the operation unit is going to be operated by, at least, a driver or a passenger on the passenger seat.

13. The apparatus according to claim 1,
wherein the operation unit has a surface that serves as an input operation surface, and
wherein an input operation on the input operation surface is controlled in accordance with the operation reference direction changed by the reference change unit.

14. The apparatus according to claim 1, wherein the operation unit comprises a touch pad.

15. The apparatus according to claim 1,
wherein the operation unit comprises a rotary switch, and
wherein a switch reference direction of the rotary switch is controlled in accordance with the operation reference direction changed by the reference change unit.

16. The apparatus according to claim 1,
wherein the operation unit comprises a shifter, and
wherein a shifter reference direction of the shifter is controlled in accordance with the operation reference direction changed by the reference change unit.
